(19) United States
(12) Patent Application Publication
(10) Pub. No.: US 2006/0232957 A1
(43) Pub. Date: Oct. 19, 2006

(54) Airport light base installation with non-conductive isolation transformer support

(76) Inventor: Roger Bieberdorf, Mesa, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/106,940

(22) Filed: Apr. 15, 2005

(51) Int. Cl. E01F 9/016; F21V 21/02

(52) U.S. Cl. 362/153.1; 362/364

(57) ABSTRACT

An airport light base container includes a continuous sidewall having an upper extremity with a light fixture assembly affixed thereto and a lower extremity with a bottom plate affixed thereto, in which there is a space in the light base container between the light fixture assembly and the bottom plate. A non-conductive support disposed in the space and is supported by the bottom plate. The non-conductive support has a non-conductive support surface disposed at an elevated location relative to the bottom plate. An isolation transformer is disposed in the space and is positioned on the non-conductive support surface of the non-conductive support and is electrically coupled to the light fixture assembly. The non-conductive support conductively isolates the isolation transformer from the bottom plate and maintains the isolation transformer at an elevated location relative to the bottom plate.

### FIELD OF THE INVENTION

The present invention relates to airport lighting systems and to airport light installations.

### BACKGROUND OF THE INVENTION

Series lighting circuitry in conjunction with a large number of lighting loads dominates airfield lighting applications. Series lighting circuitry in airfield lighting applications is technically sound, simplistic, flexible, reliable, and cost effective.

A typical series lighting circuit uses a constant current, variable voltage source to supply electrical energy to the loads connected to the circuit. The constant current regulator, isolation transformer, and series circuit wiring are the three major components of this type of lighting circuitry.

The constant currently regulator supplies the electrical energy to the series circuits, typically uses a ferroresonant type transformer and a solid-state control system, and maintains the output current to within 1% of the nominal setting over a wide range of input voltage and load conditions. Manufacturers offer constant current regulators in both air- and oil-cooled varieties, with the latter generally used for the larger sizes and higher input voltage types.

The series lighting loads are connected through series-to-series isolation transformers located at each lighting load. This device transforms the current of the primary series circuit to a secondary current while limiting the secondary voltage to no greater than a specified maximum voltage. The lighting fixture lamps in these circuits at the lighting loads are usually matched for optimum performance. The constant current and voltage range of each isolation transformer sets up the requirement for the fixture lamps. The series circuit wiring is formed by routing a single wire from the constant current regulator source to each load (one after the other) and returning it back to the constant current regulator source.

Series lighting circuitry is simple in design and inexpensive. For example, runway edge lighting design including a system of elevated lights used to outline the runway edges and ends allows for the routing of the supply and return cables together from the source to the runway. The runway edges can be looped with a single cable to supply every light. Since runways can be more than two miles long, the advantage is apparent.

The lighting loads used in series lighting circuitry in conjunction usually consist of airport light installations incorporating a container in which an isolation transformer is positioned. Typically, the isolation transformer is set onto the bottom plate of the container, or on a masonry brick positioned on the bottom plate of the container. When an isolation transformer is positioned against the bottom plate of a container, it can become damaged or rendered temporarily inoperative from electrical energy running through the bottom plate. Although isolation transformers are often placed on masonry bricks positioned against the bottom plate of a container, masonry bricks are conductive and are able transmit electrical current running through the bottom plate to the isolation transformer thus maintaining the risk of the isolation transformer becoming damaged or temporarily inoperative due to the transmission of electrical energy at the bottom plate to the isolation transformer through the masonry brick.

When an isolation transformer becomes damaged and needs replacement, the airport lighting system that the damaged isolation transformer forms a part of must be temporarily shut down. After the airport lighting system is shut down, the container housing the damaged isolation transformer must be located, its light fixture detached, the damaged isolation transformer removed. After removing the damaged isolation transformer, a new one is installed, the light fixture is reattached. At this point, the airport lighting system can be re-initialized for normal operation. This entire process is time consuming, and very expensive.

Given these and other deficiencies in the art, the need for certain new and useful improvements is evident.

### SUMMARY OF THE INVENTION

According to the invention, an airport light base installation is provided which includes a light base container including a continuous sidewall having an upper extremity and a lower extremity with a bottom plate affixed thereto. The continuous sidewall and the bottom plate bound a space in the light base container. A light fixture assembly is affixed to the upper extremity of the light base container. A non-conductive support is disposed in the space and is supported by the bottom plate. The non-conductive support has a non-conductive support surface disposed at an elevated location relative to the bottom plate. An isolation transformer disposed in the space and positioned on the non-conductive support surface of the non-conductive support and electrically coupled to the light fixture assembly. The non-conductive support conductively isolates the isolation transformer from the bottom plate and maintains the isolation transformer at an elevated location relative to the bottom plate. Series circuit wiring is coupled to the isolation transformer forming part of a series lighting circuitry of an airport lighting system. The non-conductive support consists of a non-conductive base having a lower end positioned against the bottom plate and an opposing upper end, and a non-conductive platform, having the non-conductive support surface, affixed to the upper end of the non-conductive base. The lower end of the non-conductive base further includes feet positioned against the bottom plate. An upwardly directed recess is formed into each of the feet.

According to the invention, an airport light base installation includes a light base container including a continuous sidewall having an upper extremity and a lower extremity with a bottom plate affixed thereto. The continuous sidewall and the bottom plate bound a space in the light base container. A non-conductive support is disposed in the space and is supported by the bottom plate. The non-conductive support has a non-conductive support surface disposed at an elevated location relative to the bottom plate, and an isolation transformer is disposed in the space and positioned on the non-conductive support surface of the non-conductive support, in which the non-conductive support conductively isolates the isolation transformer from the bottom plate and maintains the isolation transformer at an elevated location relative to the bottom plate. Further to this embodiment of the invention is a light fixture assembly affixed to the upper extremity of the light base container, in which the isolation transformer is electrically coupled to the light fixture assembly. Still further to the present embodiment is series circuit wiring coupled to the isolation transformer forming part of a series lighting circuitry of an airport lighting system. The non-conductive support consists of a non-conductive base having a lower end positioned against the bottom plate and an opposing upper end, and a non-conductive platform, having the non-conductive support surface, affixed to the upper end of the non-conductive base. The lower end of the non-conductive base further includes feet positioned against the bottom plate. An upwardly directed recess is formed into each of the feet.

In an airport light base installation consisting of a light base container including a continuous sidewall having an upper extremity, a lower extremity, a light fixture assembly affixed to the upper extremity of the light base container, a bottom plate affixed to the lower extremity of the light base container, a space in the light base container between the light fixture assembly and the bottom plate, and an isolation transformer disposed in the space and coupled electrically to the light fixture assembly, improvements therein according to the invention include a non-conductive support disposed in the space and supported by the bottom plate and having a non-conductive support surface disposed at an elevated location relative to the bottom plate in which the isolation transformer is positioned on the non-conductive support surface. The non-conductive support conductively isolates the isolation transformer from the bottom plate and maintains the isolation transformer at an elevated location relative to the bottom plate. The improvements according to the instant embodiment further include a light fixture assembly affixed to the upper extremity of the light base container, and the isolation transformer electrically coupled to the light fixture assembly. The improvements still further include series circuit wiring coupled to the isolation transformer forming part of a series lighting circuitry of an airport lighting system. The non-conductive support consists of a non-conductive base having a lower end positioned against the bottom plate and an opposing upper end, and a non-conductive platform, having the non-conductive support surface, affixed to the upper end of the non-conductive base. The lower end of the non-conductive base further includes feet positioned against the bottom plate. An upwardly directed recess is formed into each of the feet.

Consistent with the foregoing summary of preferred embodiments of the invention, and the ensuing specification, both of which are to be taken together, the invention also contemplates associated apparatus, improvement, and method embodiments.

### BRIEF DESCRIPTION OF THE DRAWINGS

Referring to the drawings:

FIG. 1 is an isometric view, partially in section, of an airport light base installation constructed and arranged in accordance with the principle of the invention, the airport light base installation including a light base container having an attached light fixture and an isolation transformer electrically coupled to the light fixture and supported in the light base container by a non-conductive support positioned against a bottom plate of the light base container;

FIG. 2 is a vertical sectional view of the airport light base installation of FIG. 1;

FIG. 3 is an isometric view of the non-conductive support of FIG. 1; and

FIG. 4 is a front elevational view of the non-conductive support of FIG. 1, the rear elevational view, the left side elevational view, and the right side elevational view being substantially the same thereof.

### DETAILED DESCRIPTION OF A PREFERRED EMBODIMENT

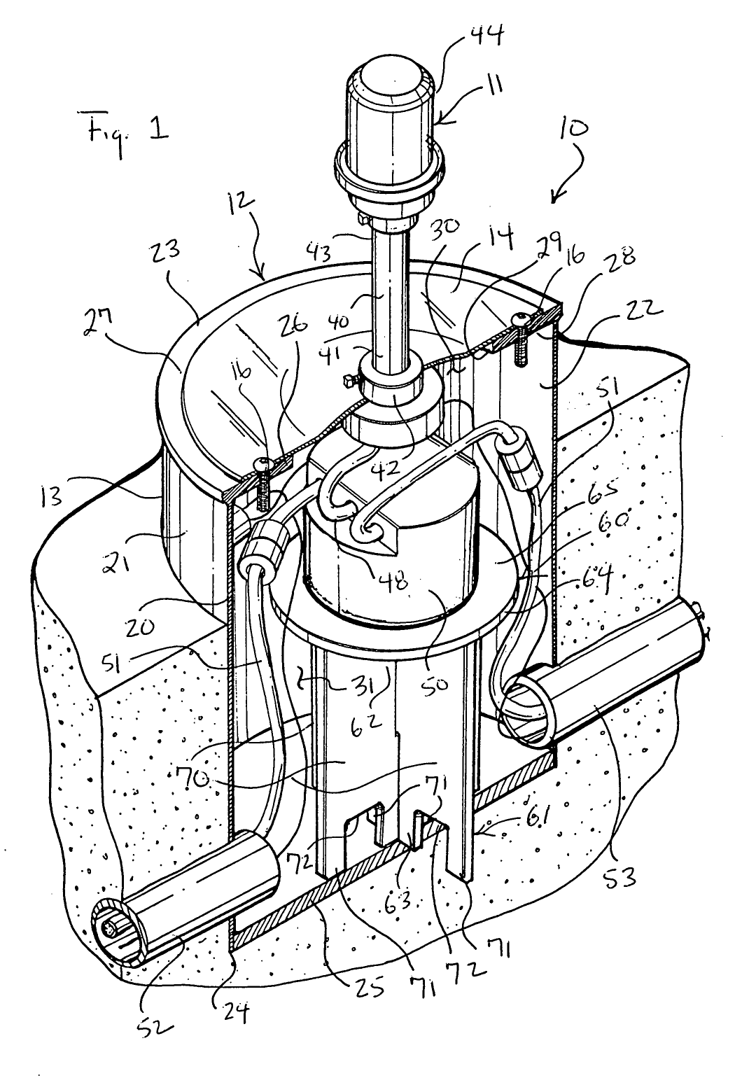

Turning now to the drawings, in which like reference characters indicate corresponding elements throughout the several views, attention is first directed to FIG. 1 in which there is seen an isometric view, partially in section, of an airport light base installation 10 constructed and arranged in accordance with the principle of the invention including a light fixture assembly 11 attached to a light base support 12. Support 12 is to be partially embedded in-ground adjacent a runway or taxiway area so as to form part of a set-in-the-ground airport lighting system.

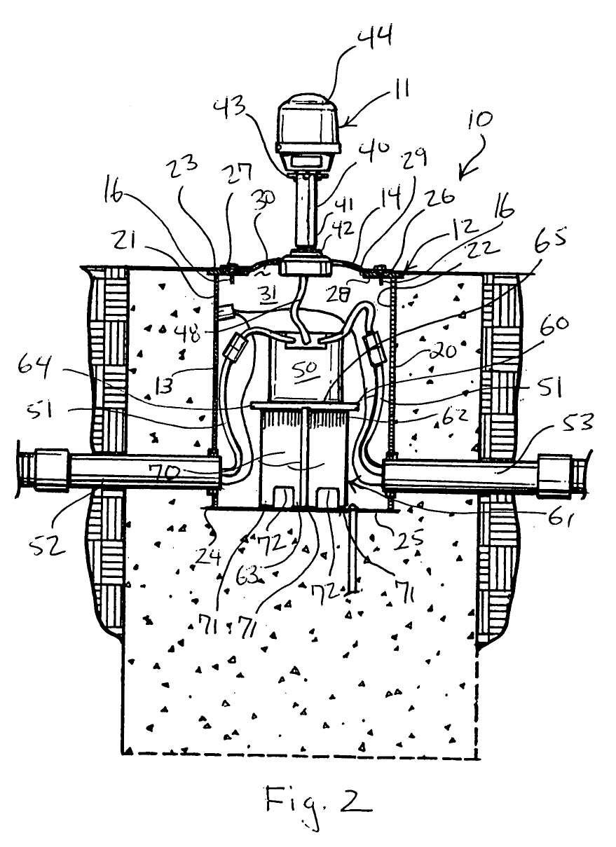

With continuing reference to FIG. 1 and additional reference to FIG. 2, support 12 consists of a light base container 13, which is attached to a cover or lid 14 forming part of light fixture assembly 11. Container 13 and lid 14 are each fashioned from steel, aluminum, or other selected metal or metal composite in accordance with conventional practice. Container 13 consists of a continuous sidewall 20 having an outer surface 21, an inner surface 22, an upper extremity 23, an opposing lower extremity 24, and a generally horizontal bottom plate 25 rigidly affixed, such as by welding, to lower extremity 24 enclosing lower extremity 24. Upper extremity 23 is constructed with an inverted flange 26 having an outer/upper face 27, an opposing inner/lower face 28 directed into container 13, and a continuous inwardly directed edge 29 bounding an opening 30 into container 13. A set of threaded bolt holes through flange 26 match a corresponding set of openings through lid 14, which permits lid 14 to be bolted onto flange 26 with threaded bolts 16 in a conventional manner. Inner surface 22 of continuous sidewall 20 and bottom plate 25 define a space 31 in container 13 between light fixture assembly 11 and bottom plate 25.

Light fixture assembly 11 additionally includes an elongate, rigid column 40 having a proximal end 41 attached to a coupling 42 secured to lid 14 at a generally central location thereof, and an opposing distal end 43. A light fixture 44 is attached to, and carried by, distal end 43 in a conventional manner. Electrical wiring 48 is coupled to light fixture 44 and passes downwardly through column 40 and coupling 42 and is electrically coupled to an isolation transformer 50 disposed in space 31 between light fixture assembly 11 and bottom plate 25. Isolation transformer 50, forming part of a series lighting circuitry, is coupled to series circuit wiring 51 extending into container 13 through either side thereof via in-ground conduits 52 and 53. Installation 10 is one lighting component or load of a specified number of lighting components or loads of an airport lighting system which are coupled in series via the series lighting circuitry, which includes series circuit wiring 51.

Light base container 13 is typical and exemplary of those that are known and currently in use in airport lighting applications. Installation 10 is an in-ground light installation, and light fixture assembly 11 is exemplary of those elevated light fixtures that are known and currently in use in airport lighting applications. Further details of container 13 and light fixture assembly 11 will readily occur to those skilled in the art and will not be discussed in further detail. It is to be understood that although container 13 incorporates an elevated light fixture assembly, it may be configured with other forms of airport light fixture assemblies, such as an inset light fixture assembly, a wig-wag light fixture assembly, or other suitable or desired light fixture assembly for use in an airport lighting system, according to the principles of the invention.

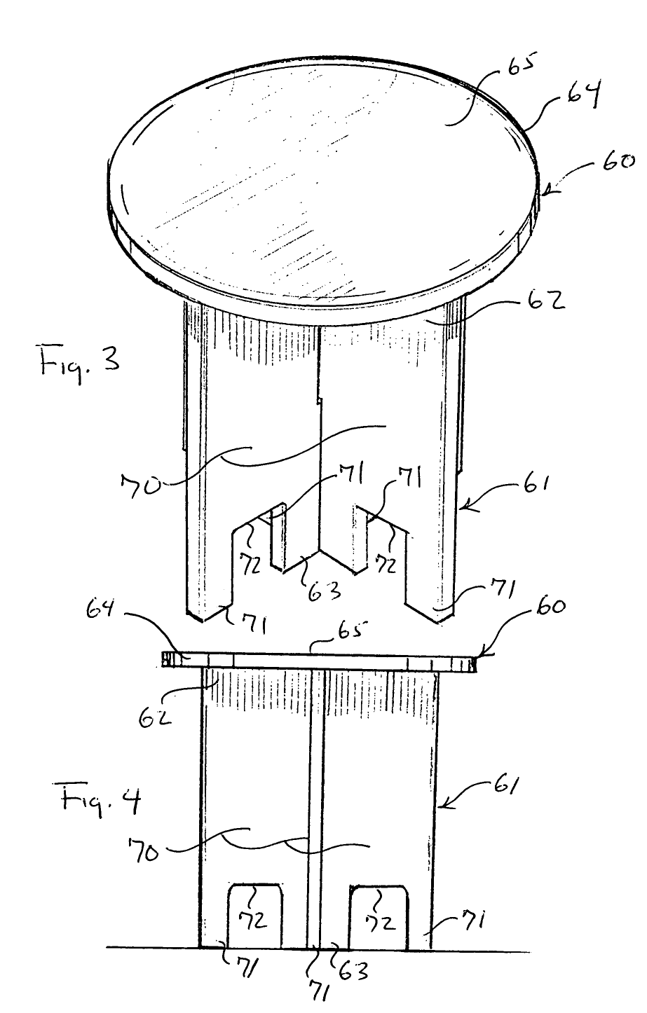

According to the invention, disposed in space 31 of light base container 13 is a non-conductive support 60. Non-conductive support 60 is made entirely of a non-conductive material or combination of non-conductive materials, such as plastic, a rubber or elastomeric material, ceramic, etc., and is integrally formed or fashioned of a plurality of two or more parts attached with a suitable non-conductive adhesive, welding, one or more joint interconnections, such as one or more tongue-and-groove interconnections or one or more other suitable joint interconnections. Support 60 consists of a base 61 having an upper end 62 and an opposing lower end 63. Upper end 62 is affixed to a platform 64 and lower end 63, as seen in FIGS. 1 and 2, is positioned against bottom plate 25. Platform 64 has a non-conductive support surface 65. As a matter of disclosure, FIG. 3 is an isometric view of non-conductive support 60, and FIG. 4 is a front elevational of non-conductive support 60, the rear elevational view, the left side elevational view, and the right side elevational view being substantially the same thereof.

As previously intimated, support 60 is disposed in space 31, and lower end 63 is positioned against bottom plate 25. Base 61 projects upwardly from bottom plate 25, and terminates at upper end 62 to which platform 64 is attached. Lower end 63 of base 61 seats stably onto bottom plate 25, and base 61 functions as a stable support for platform 64 supporting it, and its surface 65, at an elevated location relative to bottom plate 25, in which platform 64 and surface 65 are disposed in a substantially horizontal attitude and surface 65 faces and confronts light fixture assembly 11.

Base 61 supports platform 64 and its surface 65 at an elevated location relative to bottom plate 25. In this particular embodiment, base 61 includes four legs 70 which are attached to one another along substantially their entire lengths from lower end 63 of base 61 to upper end 62 of base 61, and also to platform 64. Legs 70 intersect one another at substantially right angles. Lower end 63 of base 61 is characterized by feet 71 of legs 70, which stably engage bottom plate 25. According to the invention, an upwardly directed recess 72 is formed into each foot 71, through which conduits and/or wires may be accommodated while lower end 63 is positioned against bottom plate 25 so as to maintain such conduits and/or wires in place relative to bottom plate 25.

The instant configuration for base 61 is preferred insofar as it is simple to construct and inexpensive. Base 61 can be configured in other ways so as to be positionable against bottom plate 61 for supporting platform 64 and its surface 65 at an elevated location relative to bottom plate 25. Although base 61 has four legs 70, it can include more or less, and even one, if desired, so long as that when positioned against bottom plate 25 stably supports platform 64 and its surface 65 at an elevated location relative to bottom plate 25.

According to the invention, isolation transformer 50 is positioned against surface 65 of platform 64, and is thus supported by support 60 at an elevated location relative to bottom plate 25. Surface 65 is suitably sized to provide a sufficiently large seating area for isolation transformer 50. In a typical installation, support 60 is positioned in container 13 after it is installed in-ground, isolation transformer 50 is positioned atop surface 65 of platform 64, wiring 48 of light fixture 11 is electrically coupled to isolation transformer 50, and then light fixture 11 is affixed to upper extremity 23 of container 13 by bolting it to flange 26.

Because support 60 is non-conductive, seating isolation transformer 50 onto surface 65 conductively isolates isolation transformer from bottom plate 25, which prevents isolation transformer 50 from shorting out or malfunctioning due to errant electrical energy conducting through bottom plate 25, which can occur in response to lighting strikes, water seepage in and around bottom plate 25, etc. Regardless of whatever the cause of electrical energy conducting through bottom plate 25, the provision of non-conductive support 60 positioned against bottom plate 25 supporting isolation transformer at an elevated location relative to bottom plate 25 conductively isolating isolation transformer 50 from bottom plate 25 prevents electrical energy conducting through bottom plate 25 from interacting with, and potentially interfering with the normal operation of, isolation transformer 50, according to the principle of the invention.

The present invention is described above with reference to a preferred embodiment. However, those skilled in the art will recognize that changes and modifications may be made in the described embodiment without departing from the nature and scope of the present invention. Various changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. An airport light base installation, comprising:
a light base container including a continuous sidewall having an upper extremity and a lower extremity with a bottom plate affixed thereto, the continuous sidewall and the bottom plate bounding a space in the light base container;
a light fixture assembly affixed to the upper extremity of the light base container;
a non-conductive support disposed in the space and supported by the bottom plate, the non-conductive support having a non-conductive support surface disposed at an elevated location relative to the bottom plate; and
an isolation transformer disposed in the space and positioned on the non-conductive support surface of the non-conductive support and electrically coupled to the light fixture assembly;
the non-conductive support conductively isolating the isolation transformer from the bottom plate and maintaining the isolation transformer at an elevated location relative to the bottom plate.

2. The airport light base installation according to claim 1, further comprising series circuit wiring coupled to the isolation transformer forming part of a series lighting circuitry of an airport lighting system.

3. The airport light base installation according to claim 1, wherein the non-conductive support comprises:
a non-conductive base having a lower end positioned against the bottom plate and an opposing upper end; and
a non-conductive platform, having the non-conductive support surface, affixed to the upper end of the non-conductive base.

4. The airport light base installation according to claim 3, further comprising:
the lower end of the non-conductive base further including feet positioned against the bottom plate; and
an upwardly directed recess formed into each of the feet.

5. An airport light base installation, comprising:
a light base container including a continuous sidewall having an upper extremity and a lower extremity with a bottom plate affixed thereto, the continuous sidewall and the bottom plate bounding a space in the light base container;
a non-conductive support disposed in the space and supported by the bottom plate, the non-conductive support having a non-conductive support surface disposed at an elevated location relative to the bottom plate; and
an isolation transformer disposed in the space and positioned on the non-conductive support surface of the non-conductive support;
the non-conductive support conductively isolating the isolation transformer from the bottom plate and maintaining the isolation transformer at an elevated location relative to the bottom plate.

6. The airport light base installation according to claim 5, further comprising:
a light fixture assembly affixed to the upper extremity of the light base container; and
the isolation transformer electrically coupled to the light fixture assembly.

7. The airport light base installation according to claim 5, further comprising series circuit wiring coupled to the isolation transformer forming part of a series lighting circuitry of an airport lighting system.

8. The airport light base installation according to claim 5, wherein the non-conductive support comprises:
a non-conductive base having a lower end positioned against the bottom plate and an opposing upper end; and
a non-conductive platform, having the non-conductive support surface, affixed to the upper end of the non-conductive base.

9. The airport light base installation according to claim 8, further comprising:
the lower end of the non-conductive base further including feet positioned against the bottom plate; and
an upwardly directed recess formed into each of the feet.

10. In an airport light base installation consisting of a light base container including a continuous sidewall having an upper extremity, a lower extremity, a light fixture assembly affixed to the upper extremity of the light base container, a bottom plate affixed to the lower extremity of the light base container, a space in the light base container between the light fixture assembly and the bottom plate, and an isolation transformer disposed in the space and coupled electrically to the light fixture assembly, improvements therein comprising:
a non-conductive support disposed in the space and supported by the bottom plate, the non-conductive support having a non-conductive support surface disposed at an elevated location relative to the bottom plate; and
the isolation transformer positioned on the non-conductive support surface;
the non-conductive support conductively isolating the isolation transformer from the bottom plate and maintaining the isolation transformer at an elevated location relative to the bottom plate.

11. The improvements according to claim 10, further comprising:
a light fixture assembly affixed to the upper extremity of the light base container; and
the isolation transformer electrically coupled to the light fixture assembly.

12. The improvements according to claim 11, further comprising series circuit wiring coupled to the isolation transformer forming part of a series lighting circuitry of an airport lighting system.

13. The improvements according to claim 11, wherein the non-conductive support comprises:
a non-conductive base having a lower end positioned against the bottom plate and an opposing upper end; and
a non-conductive platform, having the non-conductive support surface, affixed to the upper end of the non-conductive base.

14. The improvements according to claim 13, further comprising:
the lower end of the non-conductive base further including feet positioned against the bottom plate; and
an upwardly directed recess formed into each of the feet.
